(19) United States
(12) Patent Application Publication
(10) Pub. No.: US 2016/0209970 A1
(43) Pub. Date: Jul. 21, 2016

(54) DISPLAY DEVICE

(71) Applicant: Samsung Display Co., Ltd., Yongin-City (KR)

(72) Inventor: Sang Wol LEE, Yongin-si (KR)

(21) Appl. No.: 14/815,342

(22) Filed: Jul. 31, 2015

(30) Foreign Application Priority Data
Jan. 15, 2015 (KR) 10-2015-0007456

(51) Int. Cl. G06F 3/041

(52) U.S. Cl. CPC G06F 3/0412; G06F 2203/04102

(57) ABSTRACT

A display device includes a flexible display panel configured to display an image, a touch sensing layer, a cover window positioned over the flexible display panel, and a lower protection film disposed below the flexible display panel. At least one of the cover window and the lower protection film includes a dummy area that extends outside a first edge of the flexible display panel.

### CROSS-REFERENCE TO RELATED APPLICATION

This application claims priority from and the benefit of Korean Patent Application No. 10-2015-0007456, filed on Jan. 15, 2015, which is hereby incorporated by reference for all purposes as if fully set forth herein.

### BACKGROUND

1. Field

Exemplary embodiments relate to a display device, and more particularly, to a flexible display device.

2. Discussion of the Background

A display device is a device that displays an image. Flexible display devices are bendable and have attracted public attention in recent years.

The flexible display device may bend, fold, and twist or otherwise transform like paper. Since the shape of the flexible display device may be transformed to various shapes, the flexible display device may be used for various purposes. For example, the flexible display device may be implemented in a wearable device as well as portable devices such as a tablet, a PC, a cellular phone, and the like.

The flexible display device may warp, bend, fold, wind, twist, or roll a display module while maintaining characteristics of existing flat panel display device.

In the flexible display device, the display module is joined to a body as a case. The display module should be easily joined to the body as the shape of the display module is transformed to various shapes.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device that enables a display module to be easily joined to a body.

Additional aspects will be set forth in the detailed description which follows, and, in part, will be apparent from the disclosure, or may be learned by practice of the inventive concept.

An exemplary embodiment discloses a display device including a flexible display panel configured to display an image, a touch sensing layer, a cover window positioned over the flexible display panel, and a lower protection film disposed below the flexible display panel. At least one of the cover window and the lower protection film includes a dummy area that extends outside a first edge of the flexible display panel.

An exemplary embodiment also discloses a display device including a display module including a flexible display panel configured to display an image, a touch sensing layer disposed on the flexible display panel, a cover window disposed on the touch sensing layer, and a lower protection film disposed below the flexible display panel; and a body storing the display module. At least one of the cover window and the lower protection film in the display module includes a dummy area that extends outside a first edge of the flexible display panel and is joined to the body.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic perspective view illustrating a closed structure of a display device according to an embodiment.

FIG. 2 is an assembly perspective view illustrating a display module applied to the display device according to the embodiment.

FIG. 3 is an exploded perspective view illustrating the display module applied to the display device according to the embodiment.

FIG. 4 is a schematic cross-sectional view illustrating the display module applied to the display device according to the embodiment.

FIG. 5 is a schematic cross-section view illustrating a first modified example of the display module.

FIG. 6 is a schematic cross-section view illustrating a second modified example of the display module.

FIG. 7 is a schematic cross-section view illustrating a third modified example of the display module.

FIG. 8 is a bottom perspective view of FIG. 1.

FIG. 9 is a schematic perspective view illustrating an opened structure of the display device according to the embodiment.

FIG. 10 is a bottom perspective view of FIG. 9.

FIG. 11 is a schematic perspective view illustrating a closed structure of a display device according to an embodiment.

FIG. 12 is a schematic side view illustrating the closed structure of the display device according to an embodiment.

FIG. 13 is a schematic perspective view illustrating an opened structure of the display device according to an embodiment.

FIG. 14 is a schematic side view illustrating the opened structure of the display device according to an embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

According to an embodiment, because a separate dummy area is formed in a flexible display module of a display device, the flexible display module can be easily joined to a body through the dummy area in a sliding structure or a rolling structure.

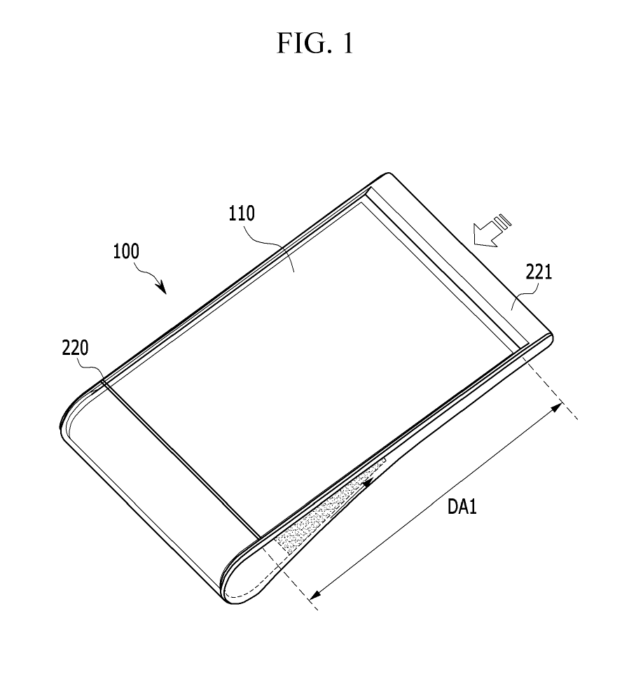

FIG. 1 is a schematic perspective view illustrating a closed structure of a display device according to an embodiment.

In an embodiment, FIG. 1 illustrates the display device 100 including a flexible display module 110 (hereinafter, “a display module”) and a body 220.

The display module 110 is fabricated by a flexible material which may be transformed by external pressure. The display module 110 may be warped, bent, folded, wound, twisted, or rolled by the external pressure.

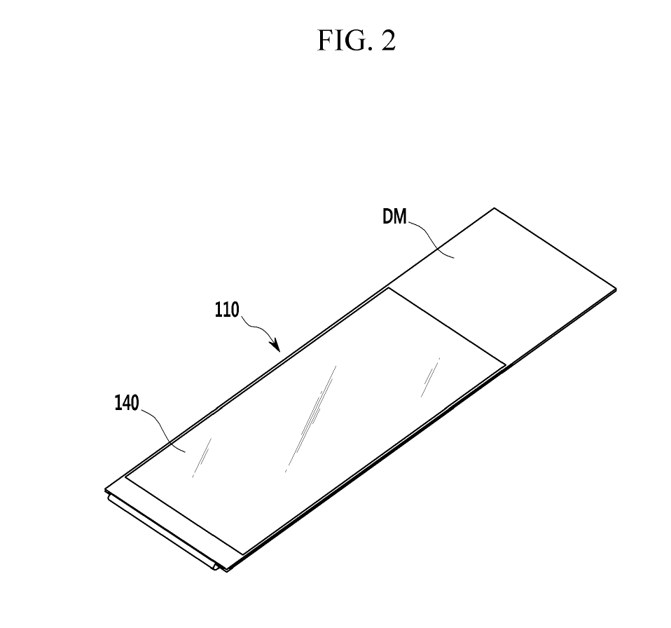

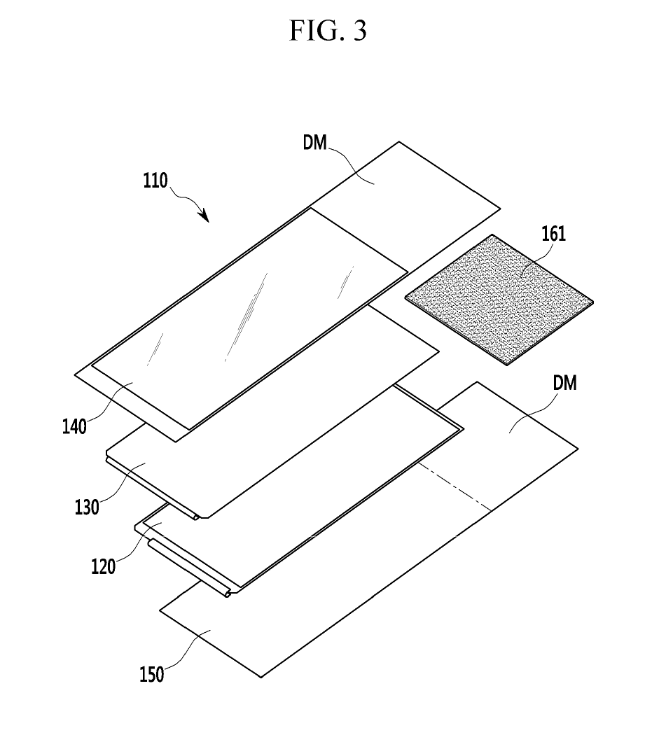

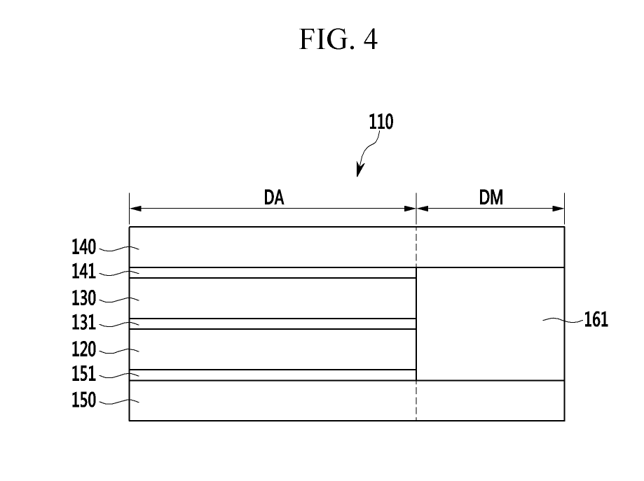

FIG. 2 is an assembly perspective view schematically illustrating the display module of a display device according to an embodiment. FIG. 3 is an exploded perspective view illustrating the display module of a display device according to an embodiment. FIG. 4 is a schematic cross-sectional view illustrating the display module of a display device according to an embodiment.

Referring to FIGS. 2 to 4, the display module 110 includes a flexible display panel 120, a touch sensing layer 130, a cover window 140, and a lower protection film 150.

The flexible display panel 120 may be fabricated by forming a plurality of pixels for displaying an image on a flexible base substrate. For example, the flexible display panel 120 of the display device 100 may display an image associated with a call through a user interface (UI) or a graphic user interface (GUI) when a mobile terminal such as a cellular phone, or the like is used.

The flexible display panel 120 may include a flexible substrate that has excellent heat resistance and durability properties. Thus, the flexible substrate may include plastic materials, such as polyethylene naphthalate (PEN), polycarbonate (PC), polyarylate (PAR), polyether imide (PEI), polyether sulfone (PES), polyimide PI, and poly(methylmethacrylate), PMMA. The substrate of the flexible display panel 120 is not limited to plastic materials listed or plastic materials generally and may include a flexible substrate made of any flexible material.

If the display module 110 is a liquid crystal display, the flexible display panel 120 may include a liquid crystal layer disposed between a first flexible substrate and a second flexible substrate. Thin film transistors, gate lines, data lines, and pixel electrodes may be disposed on the first flexible substrate while color filters and a common electrode may be disposed on the second flexible substrate.

The flexible display panel 120 may include the common electrode disposed on the flexible substrate in addition to the thin film transistors, gate lines, data lines, pixel electrodes. In this case, a minute space may be formed between a pixel electrode and the common electrode and the liquid crystal layer may be formed in the minute space.

Further, when the display module 110 is an organic light emitting display, the flexible display panel 120 may include thin film transistors, gate lines, data lines, and organic light emitting diodes that are deployed on the flexible substrate.

Furthermore, the flexible display panel 120 may be electronic paper that displays an image by using electrophoresis using a twist ball or capsule. The configurations and the driving methods of the flexible display panel 120 are not limited. Thus, the flexible display panel 120 may adopt various configurations and driving methods.

The flexible display panel 120 may include components made of a transparent material. Thus, the flexible display panel 120 may include a material that is bendable and transparent. For example, the base substrate of the flexible display panel 120 may include a transparent polymer material such as plastic. The transistors may include transparent materials such as zinc oxide, titanium oxide, and the like. In addition, the electrodes may include a transparent material such as indium tin oxide (ITO) or graphene.

The flexible display panel 120 includes a display area DA displaying the image on an entire surface.

The touch sensing layer 130 is disposed on the flexible display panel 120. The touch sensing layer 130 has a corresponding size to the flexible display panel 120 and is disposed in the same display area DA of the flexible display panel 120. The touch sensing layer 130 may adhere to the flexible display panel 120 by a second adhesive layer 131. The second adhesive layer 131 may be a pressure sensitive adhesive (PSA) sheet.

The touch sensing layer 130 senses touch. The touch sensing layer 130 may sense touch when an object actually approaches the touch sensing layer 130 or touches the touch sensing layer 130. A touch of the touch sensing layer 130 may include an external object a user's finger directly contacting the touch sensing layer 130. A touch of the touch sensing layer 130 may also include an external object approaching or hovering over the touch sensing layer 130.

In an embodiment, the touch sensing layer 130 is not disposed on the flexible display panel 120. Instead, the touch sensing layer 130 is within the flexible display panel 120. In an alternative embodiment, the touch sensing layer 130 is positioned on the flexible substrate for attachment on the flexible display panel 120. In an alternative embodiment, the touch sensing layer 130 is within the cover window 140. Other embodiments are envisioned.

In an embodiment, a polarizer (not illustrated) may be disposed on the touch sensing layer 130. The polarizer may increase a contrast ratio by reducing reflection of external light.

In an embodiment, the cover window 140 is disposed on the touch sensing layer 130 and positioned outside a portion of flexible display panel 120.

The cover window 140 serves to protect the flexible display panel 120 and the touch sensing layer 130 from external forces and pollution. The cover window 140 is made of glass or a transparent resin to protect the flexible display panel 120 and the touch sensing layer 130 from external shock while transmitting the unaltered image of the flexible display panel 120. Although FIGS. 2-7 illustrate an exemplary cover window 140 having a single layer structure, the cover window 140 may be formed in a single-layer structure or a multi-layer structure.

The cover window 140 may adhere to the touch sensing layer 130 by a first adhesive layer 141. The first adhesive layer 141 may be a pressure sensitive adhesive (PSA) sheet.

In an embodiment, the cover window 140 covers the display area DA of the flexible display panel 120 and further includes a dummy area DM that extends outside a first edge of the flexible display panel 120.

The dummy area DM extends outside a first edge of the flexible display panel 120 and the touch sensing layer 130 in an area covering the display area DA of the flexible display panel 120 and the touch sensing layer 130 corresponding to the display area DA. Thus, the dummy area DM may be formed by a non-display area divided to neighbor the display area DA of the flexible display panel 120.

The lower protection film 150 is disposed below (on the bottom of) the flexible display panel 120. The lower protection film 150 absorbs outside shock to prevent the flexible display panel 120 and the touch sensing layer 130 from being damaged. In an embodiment, the lower protection film 150 may be a shock absorbing material including air, such as a cushion or a sponge.

In an embodiment, the lower protection film 150 may include a sixth adhesive layer (not illustrated) for attaching the flexible display panel 120 to other parts (e.g., a case). The lower protection film 150 may adhere to the bottom of the flexible display panel 120 by a third adhesive layer 151. The third adhesive layer 151 may be a pressure sensitive adhesive (PSA) sheet.

In an embodiment, the lower protection film 150 further includes the dummy area DM that extends outside a first edge of the flexible display panel 120 to correspond to the dummy area DM of the cover window 140. The dummy area DM extends outside a first edge of the flexible display panel 120 and the touch sensing layer 130 in an area corresponding to the display area DA of the flexible display panel 120. Thus, the dummy area DM may be formed by the non-display area divided to neighbor the display area DA of the flexible display panel 120.

In an embodiment, the dummy area DM of the cover window 140 and the lower protection film 150 may adhere to each other through a fourth adhesive layer 161. The fourth adhesive layer 161 may be positioned between the dummy areas DM of the cover window 140 and the lower protection film 150. The fourth adhesive layer 161 may be pressure sensitive adhesive (PSA) sheet.

Accordingly, the display module 110 including the flexible display panel 120, touch sensing layer 130, cover window 140, and lower protection film 150 may have flexibility and may be warped, bent, folded, wound, twisted, or rolled.

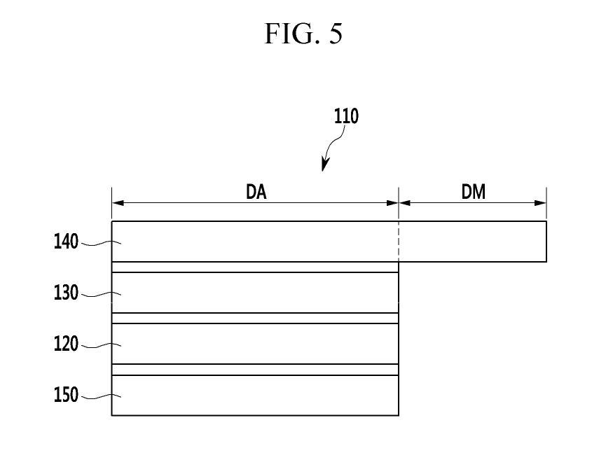

FIGS. 5, 6, and 7 are schematic cross-sectional views illustrating modified examples of the display module of the display device according to the embodiment.

FIG. 5 illustrates a first modified example of a display module 110. Modified display module 110 of FIG. 5 is similar to the display module of FIG. 4 except the modified display module 110 of FIG. 5 does not include the lower protection film 150 in the dummy area DM. Instead, the modified display module 110 of FIG. 5 only includes the cover window 140 in the dummy area DM.

The dummy area DM of the cover window 140 extends outside a first edge of the flexible display panel 120, the touch sensing layer 130, and the lower protection film 150 in the area corresponding to the display area DA of the flexible display panel 120. Thus, the dummy area DM may be formed by the non-display area divided to neighbor the display area DA of the flexible display panel 120.

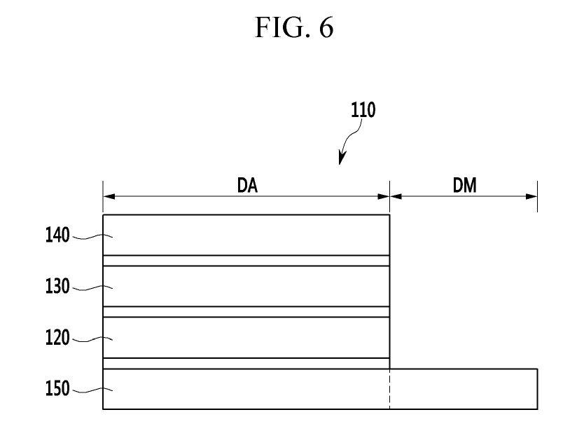

FIG. 6 illustrates a second modified example of a display module 110. Modified display module 110 of FIG. 6 is also similar to the display module 110 of FIG. 4 except the display module 110 of FIG. 6 does not include the cover window 140 in the dummy area DM. Instead, the modified display module 110 of FIG. 6 only includes the lower protection film 150 in the dummy area DM.

The dummy area DM of the lower protection film 150 extends outside a first edge of the flexible display panel 120, the touch sensing layer 130, and the cover window 140 in the area corresponding to the display area DA of the flexible display panel 120. Thus, the dummy area DM may be formed by the non-display area divided to neighbor the display area DA of the flexible display panel 120.

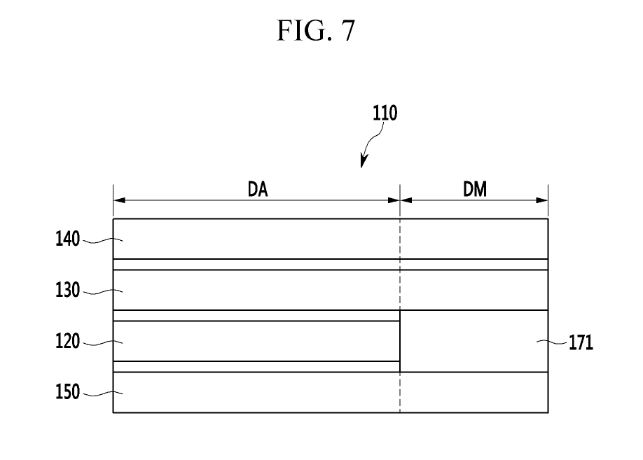

FIG. 7 illustrates a third modified example of a display module 110. Modified display module 110 of FIG. 7 is also similar to the display module 110 of FIG. 4 except the display module 110 of FIG. 7 also includes the touch sensing layer 130 in the dummy area DM.

The dummy areas DM of the touch sensing layer 130, the cover window 140, and the lower protection film 150 extend outside a first edge of the flexible display panel 120 in the area corresponding to the display area DA of the flexible display panel 120. Thus, the dummy area DM may be formed by the non-display area divided to neighbor the display area DA of the flexible display panel 120.

The dummy areas DM of the touch sensing layer 130 and the lower protection film 150 may adhere to each other through a fifth adhesive layer 171. The fifth adhesive layer 171 may be positioned between the dummy areas DM of the touch sensing layer 130 and the lower protection film 150. The fifth adhesive layer 171 may be a pressure sensitive adhesive (PSA) sheet.

In an embodiment, the dummy areas and the display areas DA of the cover window 140 and the touch sensing layer 130 may adhere to each through the first adhesive layer 141 shown in FIG. 4.

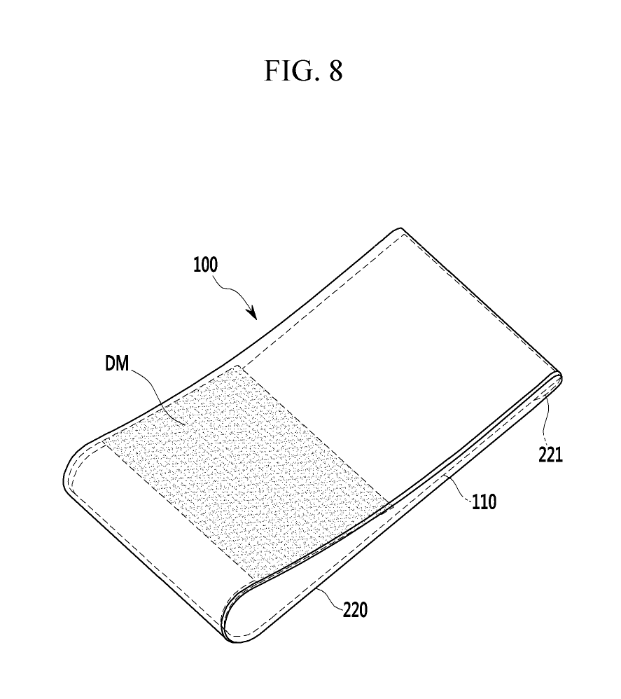

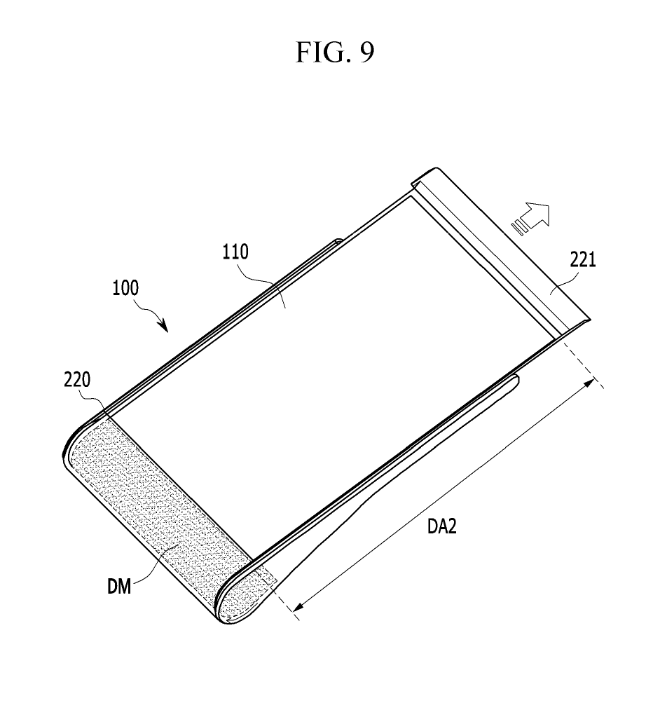

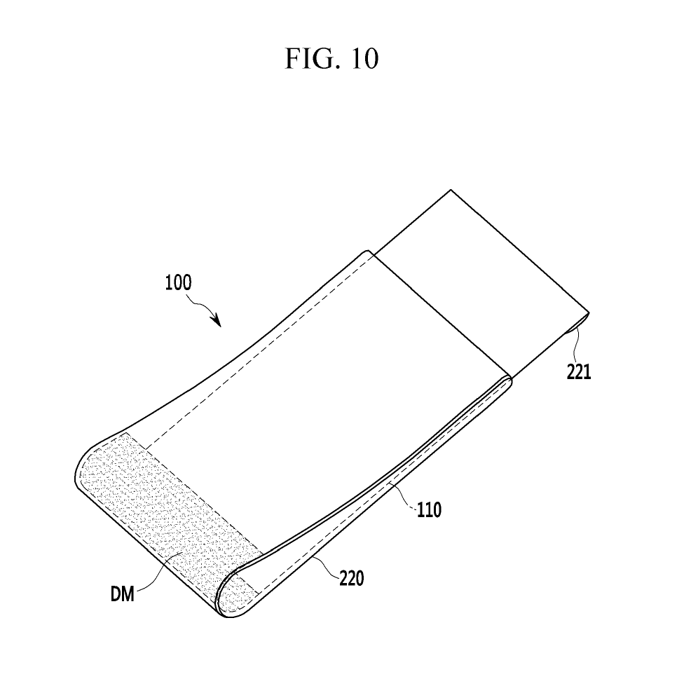

FIG. 8 is a bottom perspective view of FIG. 1. FIG. 9 is a schematic perspective view illustrating an opened structure of the display device according to the embodiment. FIG. 10 is a bottom perspective view of FIG. 9.

Referring to FIGS. 8, 9, and 10 together with FIG. 1, a body 220 serves as a case that stores the display module 110 by a sliding method.

The dummy area DM of the display module 110 is disposed at a first edge of the display module 110. While the display device 100 is closed (FIG. 1), a part of the display area at the first edge of the display module 110 (an area corresponding to a width of DA2 minus DA1 illustrated in FIGS. 1 and 9) may enter the inside of the body 220 together with the dummy area DM. In an embodiment, the part (the area corresponding to the width of DA2−DA1) of the display area of the display module 110 and the dummy area DM may be slidably joined to the inside of the body 220.

The body 220 may include a grip portion 221. The grip portion 221 is attached to a second edge of the display module 110 opposite the first edge. The grip portion 221 may be formed as a bracket having a length corresponding to the first edge of the display module 110 and may be fixed to the second edge of the display module 110. When a user grips and pulls the grip portion 221, the part of the display area that enters the inside of the body 220 comes out. In this manner, the dummy area DM of the display module 110 slides together with the part of the display area in the body 220 while being supported on the body 220.

In an embodiment, the body 220 may be fixed to the display module 110 through a stopper (not illustrated) to prevent the display module 110 from coming out in an opened state. The opened state is when a part of the display area of the display module 110 comes out from the body 220.

As illustrated in FIG. 1, the display area of the display module 110 has a width DA1 in a closed state of the display device 100. When the user pulls the grip portion 221, the display device 100 is transformed to an opened state illustrated in FIG. 9. In the opened state, the display area of the display module 110 extends to a width which of DA2, which is larger than DA1. In an embodiment, the stopper fixed to the display module 110 stops the display module from being pulled too far so that the display module 110 has a width no larger than DA2 while in the opened state of the display device 100.

Herein, the closed state or the closed structure of the display device 100 means a state in which a part of the display area of the display module 110 enters the inside of the body 220 and is not viewed by the user. In addition, the opened state or the opened structure of the display device 100 means a state in which a part of the display area of the display module 110 comes out from the inside of the body 220 while the dummy area DM is fixed to the inside of the body 220. In the opened state, the entire display area of the display module 110 is viewed by the user.

In an embodiment, a button (not illustrated) for releasing the stopper is provided in the body 220. When the user presses the button, elastic restoration force of an elastic member (not illustrated) causes a part of the display area of the display module 110 to enter the inside of the body 220 again with the dummy area DM. Thus, pressing the button releases the stopper and causes the display device 100 to return to the closed state. Specifically, the dummy area DM of the display module 110 slides together with the part of the display area into the body 220 while being supported on the body 220.

As described above, a sliding method may be used to place the display module 110 in or out of the body 220. The body 220 may have various shapes to accommodate the display module 110 sliding in and out from it.

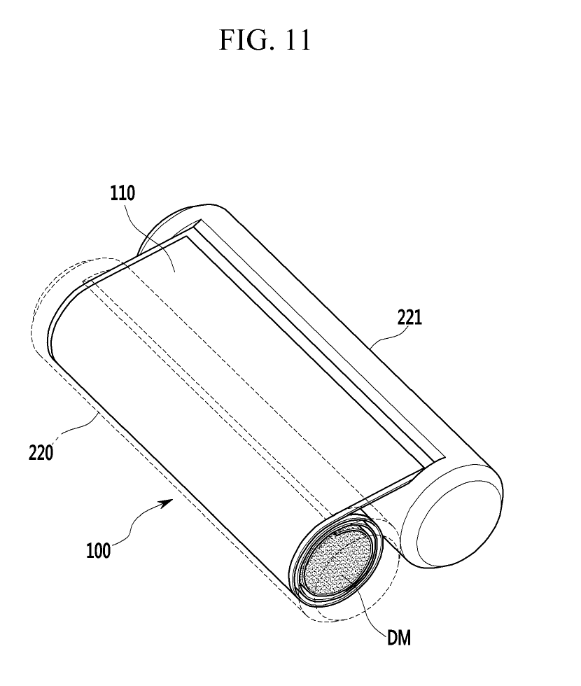

Next, a display device having a rolling structure will be described in detail with reference to FIGS. 11 to 14. The display device having the rolling structure has some configurations of the body 220 that different to the display device having the sliding structure and some configurations of the body 220 are the same. The same/similar configuration of the display device having the sliding structure will be described in brief.

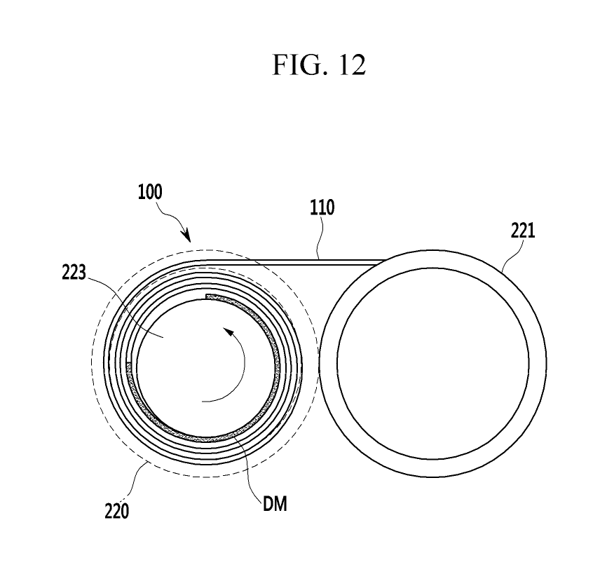

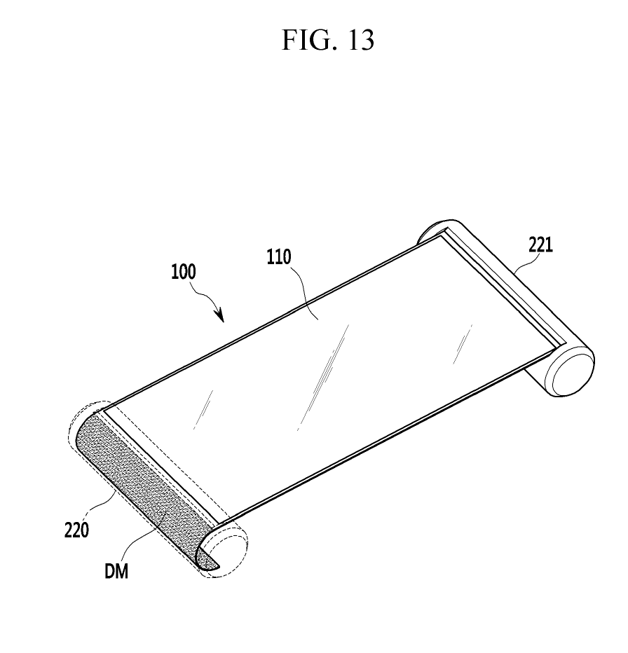

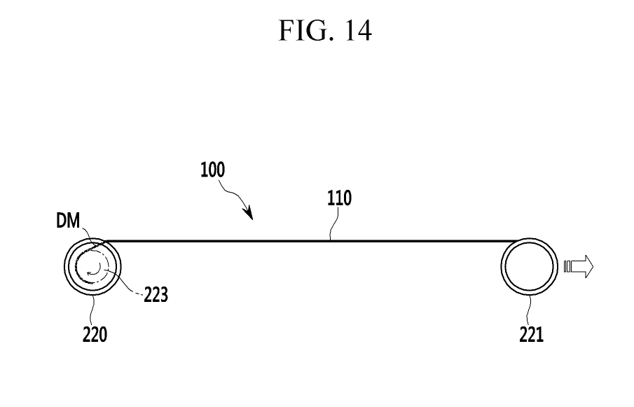

FIG. 11 is a schematic perspective view illustrating a closed structure of a display device according to an embodiment. FIG. 12 is a schematic side view illustrating the closed structure of the display device according to an embodiment. FIG. 13 is a schematic perspective view illustrating an opened structure of the display device according to an embodiment. FIG. 14 is a schematic side view illustrating the opened structure of the display device according to an embodiment.

Referring to FIGS. 11, 12, 13, and 14, the display device 100 includes the display module 110 and the body 220. The body 220 serves as a case containing the display module 110 by a rolling method. The body 220 includes the grip portion 221 and a rotor 223.

The display module 110 includes the dummy area DM at a first edge. In the closed state, the display module 110 of the display device 100 is rolled inside of the body 220 entering through a gap in the body 220. More specifically, the display module 110 is rolled together with the dummy area DM to enter the inside the body 220 while the display device 100 is in the closed state.

The body 220 may have a cylindrical shape. The display module 110 may be attached to and rolled by the rotor 223 into the cylindrical shaped body 220. In the closed state, the display module 110 of the display device 100 is wound on the rotor 223 together with the dummy area DM. The dummy area DM of the display module 110 may be joined to the rotor 223.

The grip portion 221 may be attached to a second edge of the display module 110 opposite the first edge of the display module 110. The grip portion 221 may have a cylindrical shape and may be fixed to the second edge of the display module 110. When the user pulls the grip portion 221, the display module 110 which is rolled in the body 220 comes out of the body 220.

The rotor 223 may be rotatably installed in the body 220 so that the rotor 223 may roll the display area of the display module 110 and simultaneously be fixed to the dummy area DM of the display module 110.

The rotor 223 may include a stopper (not illustrated). In the opened state (which the entire display area of the display module 110 comes out from the inside of the body 220), the stopper may stop the rotor 223 from rotating. The stopper may have a switch shape that stops an operation of a gear for rotating the rotor 223 or the stopper may a general rolling structure. When the entire display area of the display module 110 comes out from the inside the body 220, the dummy area DM of the display module 110 is fixed to the rotor 223 in the body 220. As a result, the display device 100 is in the opened state as illustrated in FIGS. 13 and 14.

A body 220 may include a button (not illustrated) for releasing the stopper. When the user presses the button, elastic restoration force of an elastic member (not illustrated) causes the rotor 223 to rotate in a reverse direction and the display area of the display module 110 enters the inside of the body 220 rolling over the rotor 223 together with the dummy area DM. As a result, the display device 100 transformed to the closed state as illustrated in FIGS. 11 and 12.

Herein, the closed state or the closed structure of the display device 100 means a state in which a part of the display area of the display module 110 comes out between the body 220 and the grip portion 221 and the remaining display area enters the inside of the body 220. In the close state, the remaining display area is not viewed by the user. In addition, the opened state or the opened structure of the display device 100 means a state in which the entire display area of the display module 110 comes out from the inside of the body 220 and the entire display area of the display module 110 is viewed by the user.

As described above, the body 220 according to another embodiment may take in and out the display module 110 by the rolling method. When the body 220 may take out the display module 110 from the inside to the outside or take in the display module 110 from the outside to the inside again by the rolling method, the body 220 may have various known shapes.

According to an exemplary embodiment, since a separate dummy area is formed in a flexible display module, the flexible display module can be easily joined to a body through the dummy area in a sliding structure or a rolling structure.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device comprising:
a flexible display panel configured to display an image;
a touch sensing layer;
a cover window positioned over the flexible display panel; and
a lower protection film disposed below the flexible display panel,
wherein at least one of the cover window and the lower protection film comprise a dummy area that extends outside a first edge of the flexible display panel.

2. The display device of claim 1, wherein the touch sensing layer is selected from the group consisting of:
a combined layer within the cover window;
a combined layer within the flexible display panel;
a separate layer disposed on the flexible substrate; and
a separate layer disposed on the flexible display panel.

3. The display device of claim 1, wherein:
the touch sensing layer is a separate layer disposed on the flexible display panel, and wherein the cover window is disposed on the touch sensing layer.

4. The display device of claim 3, wherein:
the dummy area is formed by a non-display area divided from a display area of the flexible display panel.

5. The display device of claim 3, wherein:
the cover window is adhered to the touch sensing layer via a first adhesive layer;
the touch sensing layer is adhered to the flexible display panel via a second adhesive layer; and
the flexible display panel is adhered to the lower protection film via a third adhesive layer.

6. The display device of claim 5, wherein:
the cover window and the lower protection firm comprise dummy areas, and the dummy areas of the cover window and the lower protection film adhere to each other through a fourth adhesive layer.

7. The display device of claim 3, wherein:
the cover window, the touch sensing layer, and the lower protection film each comprise a dummy area that extends outside the first edge of the flexible display panel

8. The display device of claim 7, wherein:
the cover window is adhered to the touch sensing layer via a first adhesive layer;
the touch sensing layer is adhered to the flexible display panel via a second adhesive layer;
the flexible display panel is adhered to the lower protection film via a third adhesive layer; and
the dummy areas of the touch sensing layer and the lower protection film adhere to each other via a fifth adhesive layer.

9. A display device comprising:
a display module comprising a flexible display panel configured to display an image, a touch sensing layer disposed on the flexible display panel, a cover window disposed on the touch sensing layer, and a lower protection film disposed below the flexible display panel; and
a body storing the display module,
wherein in the display module, at least one of the cover window and the lower protection film comprises a dummy area that extends outside a first edge of the flexible display panel and is joined to the body.

10. The display device of claim 9, wherein:
the cover window, the touch sensing layer, and the lower protection film each comprise a dummy area that extends outside the first edge of the flexible display panel.

11. The display device of claim 9, wherein:
the body is substantially joined to the dummy area disposed at the first edge of the display module and is configured to store the display module by a sliding method.

12. The display device of claim 11, wherein the body comprises:
a grip portion attached to a second edge of the display module opposite the first edge.

13. The display device of claim 12, wherein:
the grip portion is formed as a bracket having a length corresponding to the first edge of the display module and fixed to the second edge of the display module.

14. The display device of claim 11, wherein:
a part of the display area at the first edge of the display module is inside of the body together with the dummy area when the display device is in a closed state.

15. The display device of claim 11, wherein:
the entire display of the display module is out from the body when the display device is in an open state.

16. The display device of claim 9, wherein:
the body is substantially joined with the dummy area disposed at the first edge of the display module and is configured to store the display module by a rolling method.

17. The display device of claim 16, wherein:
the body comprises a grip portion attached to a second edge of the display module opposite the first edge, the grip portion having a cylindrical shape and fixed to the second edge of the display module.
